(19) United States
(12) Patent Application Publication
(10) Pub. No.: US 2024/0183662 A1
(43) Pub. Date: Jun. 6, 2024

(54) MICROMECHANICAL SENSOR SYSTEM COMPRISING A ROTATION RATE SENSOR AND METHOD FOR OPERATING A MICROMECHANICAL SENSOR SYSTEM COMPRISING A ROTATION RATE SENSOR

(71) Applicant: Robert Bosch GmbH, Stuttgart (DE)

(72) Inventors: Francesco Diazzi, Muenchen (DE); Gabriele Cazzaniga, Rosate MI (IT); Ruslan Khalilyulin, Muenchen (DE); Thorsten Balslink, Kirchentellinsfurt (DE)

(21) Appl. No.: 18/489,534

(22) Filed: Oct. 18, 2023

(30) Foreign Application Priority Data
Dec. 6, 2022 (DE) 10 2022 213 104.5

(51) Int. Cl. G01C 19/56

(52) U.S. Cl. CPC G01C 19/56

(57) ABSTRACT

A micromechanical sensor system including a rotation rate sensor and a method for operating the system. The rotation rate sensor includes a seismic mass, and a drive device. For driving, the seismic mass is subjected to an offset voltage and a drive voltage. The seismic mass is excited to oscillate using the drive voltage. The rotation rate sensor can selectively be operated in a start-up mode and in an operating mode. The offset voltage during operation of the rotation rate sensor in the start-up mode is different from the offset voltage during operation of the rotation rate sensor in the operating mode, and/or the maximum voltage available from the driver of the drive voltage during operation of the rotation rate sensor in the start-up mode is different from the maximum voltage available during operation of the rotation rate sensor in the operating mode.

### CROSS REFERENCE

The present application claims the benefit under 35 U.S.C. § 119 of German Patent Application No. DE 10 2022 213 104.5 filed on Dec. 6, 2022, which is expressly incorporated herein by reference in its entirety.

### FIELD

The present invention relates to a micromechanical sensor system comprising a rotation rate sensor.

### BACKGROUND INFORMATION

The maximum available driving force for exciting the seismic mass results from the product of the offset voltage and the maximum voltage available from the driver of the drive voltage in conjunction with the pulse shape of the drive voltage.

The offset voltage applied to the seismic mass of a micromechanical sensor system comprising a rotation rate sensor (or to which the seismic mass is subjected) is one of the most important parameters for (efficient) operation of such a (micromechanical) sensor system. On the one hand, a comparatively high offset voltage (approximately in the range of 5V-50V) achieves the advantage that the micromechanical sensor system has a high sensitivity, in particular for detecting the drive and detection oscillation of the seismic mass. On the other hand, a comparatively high offset voltage increases the available driving force.

However, a high offset voltage also results in high power consumption as well as undesirable feedback effects within the circuit.

A high available maximum voltage of the driver of the drive voltage likewise increases the maximum available driving force, but also results in increased power consumption.

Conventional micromechanical sensor systems comprising a rotation rate sensor are traditionally operated with only a specific offset voltage.

The maximum available drive voltage in the start-up phase and in the operating mode is typically identical as well.

In addition to increasing the maximum offset voltage and the maximum voltage available from the driver of the drive voltage, the driving force can be further increased by applying a square wave voltage instead of a sine wave voltage to the drive electrodes.

In most cases, the offset voltage is selected to be comparatively high in order to ensure a (comparatively) quick start-up phase due to higher forces on the drive electrodes.

Another advantage is that the operating mode can be achieved comparatively more quickly, as a result of which the micromechanical sensor system can be used efficiently, is in particular ready for use more quickly. Alongside these advantages, however, stands the fact that the generation of a higher voltage represents a comparatively high or higher energy consumption.

When (energy-efficiently) selecting a lower offset voltage, it is indeed possible to maintain the drive voltage of the sensor system in the operating mode by adjusting/increasing the quality factor of the mechanical structure/sensor system, but this cannot compensate the disadvantage of the comparatively slow achievement of the operating mode.

Increasing the maximum voltage available from the driver of the drive voltage also shortens the start-up phase, but leads to higher energy consumption in the operating mode.

To bring the seismic mass to the target amplitude as quickly as possible, excitation occurs in the start-up phase by applying the maximum voltage available from the driver of the drive voltage to the drive electrodes and the available offset voltage to the center mass until the target amplitude is reached and the drive voltage is switched to regulated operation. The drive voltage required in the operating mode is significantly lower than the maximum voltage available from the driver of the drive voltage.

The maximum voltage available from the driver of the drive voltage is thus needed only in the start-up phase to shorten the start-up time.

### SUMMARY

It is an object of the present invention to provide a micromechanical sensor system comprising a rotation rate sensor, with which it is possible, on the one hand, to realize efficient, in particular energy-efficient, operation and, on the other hand, nonetheless realize a comparatively fast start-up time to the operating mode.

A micromechanical sensor system according to the present invention comprising a rotation rate sensor may have the advantage over the prior art that, by selecting different used values or levels of the offset voltage and/or the maximum voltage available from the driver of the drive voltage (in particular different dynamically adjusted levels of these parameters) between the start-up mode and the operating mode, it is possible to shorten the start-up mode, in particular by means of a comparatively short and higher energy consumption owing to a higher offset voltage and/or a higher maximum voltage available from the driver of the drive voltage, and nonetheless use the micromechanical sensor system or its rotation rate sensor as efficiently as possible and thus in an energy-saving manner in a comparatively long operating mode, in particular by using lower or reduced values of the offset voltage and/or the maximum voltage available from the driver of the drive voltage (relative to the start-up mode) during the operating mode. The various advantages of different levels of the offset voltage and/or the maximum voltage available from the driver of the drive voltage can thus be advantageously combined.

Advantageous embodiments and further developments of the present invention emerge from the disclosure herein.

According to one advantageous embodiment of the present invention, it is provided that the offset voltage in the start-up mode is 20 to 30 V, for example, while a voltage of 10 to 20V, for example, is preferred in the operating mode. Since this shortens the start-up mode, it advantageously allows an energy-efficient use of the sensor system in the operating mode.

According to one advantageous embodiment of the present invention, it is provided that the offset voltage is generated or can be applied with the aid of a charge pump. It is therefore advantageously possible to generate the offset voltage by means of a charge pump that can typically be operated in an energy-efficient manner.

According to one advantageous embodiment of the present invention, it is provided that the maximum voltage available from the driver of the drive voltage during the start-up mode increases to 3 to 5V, for example, via another operating mode (of the driver of the drive voltage), while the maximum voltage available from the drive voltage in the operating mode is reduced to 1.5 to 3V, for example.

According to one advantageous embodiment of the present invention, it is provided that the oscillation amplitude of the seismic mass is maintained in the operating mode despite the reduced offset voltage and/or the reduced maximum voltage available from the driver of the drive voltage by adjusting the quality factor of the mechanical structure. An advantage of this embodiment is that it is in particular possible to compensate the lower offset voltage and/or the lower maximum voltage available from the driver of the drive voltage by adjusting the quality factor of the mechanical structure (to a higher level) in the design.

According to one advantageous embodiment of the present invention, it is provided that the maximum voltage available from the driver of the drive voltage and/or the offset voltage is/are changed incrementally, in particular in several steps, or abruptly, in particular in one step, from its/their value(s) during the start-up mode to its/their value(s) during the operating mode. It is therefore advantageously possible to ensure a comparatively quick transition from the start-up mode to the operating mode.

There is moreover a switch from excitation with the maximum voltage available from the driver of the drive voltage to the regulated operation of the drive voltage.

According to one advantageous embodiment of the present invention, it is provided that a square wave voltage is used as the drive voltage during the start-up mode and to then, in one of the switching steps, switch to a sine wave voltage as the drive voltage. Excitation with a sine wave voltage avoids the occurrence of undesirable, high-frequency spectral components of the stimulating driving forces that occur with square-wave excitation.

According to one advantageous embodiment of the present invention, it is provided that the rotation rate sensor can be operated in a sleep mode and said sleep mode is carried out chronologically before the start-up mode and the operating mode, wherein the period of time between the sleep mode and the operating mode corresponds to the time interval of the start-up mode and wherein this includes a period of time of less than 100 milliseconds, in particular less than 50 milliseconds. It is therefore advantageously possible to ensure a comparatively quick transition from the sleep mode to the operating mode.

A further subject matter of the present invention is a method for operating a micromechanical sensor system comprising a rotation rate sensor.

The method according to an example embodiment of the present invention for operating a micromechanical sensor system comprising a rotation rate sensor may be advantageous over the prior art in that, due to the option of operating the micromechanical sensor system comprising the rotation rate sensor in two different modes with different levels of the offset voltage and/or the maximum voltage available from the driver of the drive voltage, an energy-efficient operation and nonetheless a comparatively short start-up time (or duration of the start-up mode) is possible. It is in particular provided that the use of two different (voltage) levels makes it possible to effectively/significantly shorten the start-up mode and nonetheless use or operate the micromechanical sensor system or the rotation rate sensor in an (energy) efficient manner.

The advantages and configurations described in connection with the embodiments of the micromechanical sensor system and the rotation rate sensor according to the present invention apply likewise to the method for operating a micromechanical sensor system comprising a rotation rate sensor.

Embodiment examples of the present invention are shown in the figures and explained in more detail in the following description.

### BRIEF DESCRIPTION OF THE DRAWINGS

FIG. 1 shows a schematic basic circuit diagram of a micromechanical sensor system comprising a rotation rate sensor according to an embodiment example of the present invention.

FIG. 2 shows a block diagram of the micromechanical sensor system or the rotation rate sensor according to an example embodiment of the present invention.

FIGS. 3 and 4 respectively show a graphic illustration of the start-up mode and the operating mode of the micromechanical sensor system and the rotation rate sensor according to different embodiment examples of the present invention.

### DETAILED DESCRIPTION OF EXAMPLE EMBODIMENTS

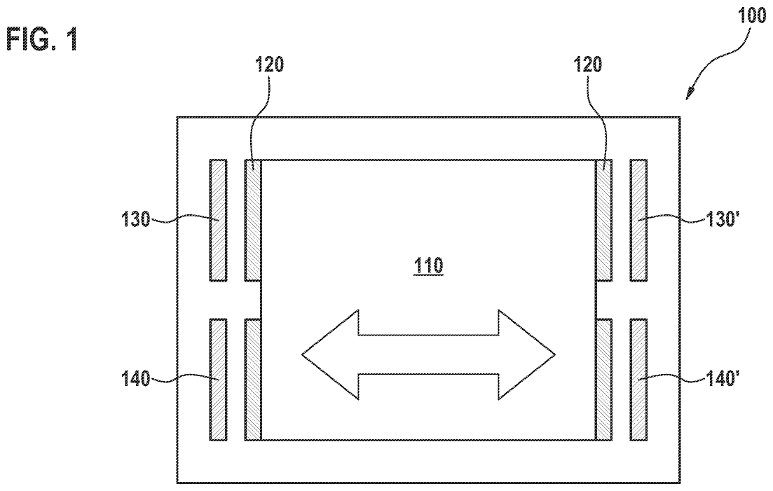

FIG. 1 is a very schematic basic circuit diagram of a micromechanical sensor system 100 comprising a rotation rate sensor according to the present invention. The rotation rate sensor typically comprises a seismic mass 110 and a substrate (not shown in FIG. 1) of the micromechanical arrangement.

FIG. 1 in particular shows the circuit diagram of the drive of the rotation rate sensor and/or the seismic mass 110 of the rotation rate sensor of the sensor system 100, including, on the one hand, the actual drive by means of electrodes 120 of the seismic mass 110 and substrate-fixed drive electrodes 130, 130′, and, on the other hand, including a drive sensing device (or drive detection device) likewise comprising the electrodes 120 of the seismic mass 110 as well as substrate-fixed sensor electrodes 140, 140′. The seismic mass 110 is realized in the usual manner as a mass 110 which can be excited to oscillations or drive oscillations and to which an electrical offset voltage, in particular generated by a charge pump, can be applied, so that the seismic mass 110 can be driven by applying a drive voltage in the form of an AC voltage between a respective electrode 120 of the seismic mass on the one hand and the drive electrodes 130, 130′ on the other hand (or by applying such a drive voltage between respective adjacent or opposite electrodes 120, 130, 130′). According to the present invention, the drive electrodes 130, 130′ are subjected to a respective drive voltage or a drive signal to drive seismic mass 110. The sensor electrodes 140 and 140′ are used to sense or read out or detect the amplitude of this mechanical oscillation or drive oscillation of the seismic mass 110, wherein the readout signal is forwarded to an output unit.

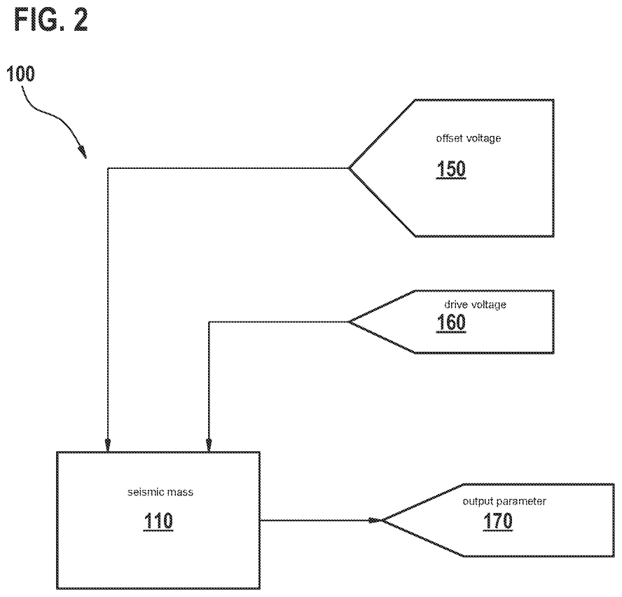

In FIG. 2 schematically shows a block diagram of the micromechanical sensor system 100 comprising a rotation rate sensor according to the present invention; in particular a block diagram of the drive system. The micromechanical sensor system 100 comprises the rotation rate sensor, which in turn comprises the seismic mass 110. In addition to a charge pump labeled with the reference sign 150, by means of which in particular the offset voltage is generated and defined, the figure also shows a drive voltage or a drive signal labeled with the reference sign 160 as an input parameter of the drive system of the rotation rate sensor. The latter represents an AC voltage for driving the seismic mass 110. In an operating mode of the sensor system according to the present invention (which is permanent or at least takes a comparatively longer period of time) the seismic mass 110 of the rotation rate sensor is subjected to the offset voltage 150 and excited to mechanical oscillations by means of the drive voltage 160 (as an AC voltage). A measurement signal, evaluated or measured by the sensor electrodes 140 and 140′, is provided as the output parameter 170 which reflects the drive oscillation of the seismic mass 110; according to the present invention the oscillation of the seismic mass 110 is in particular forwarded to a signal read out unit 170.

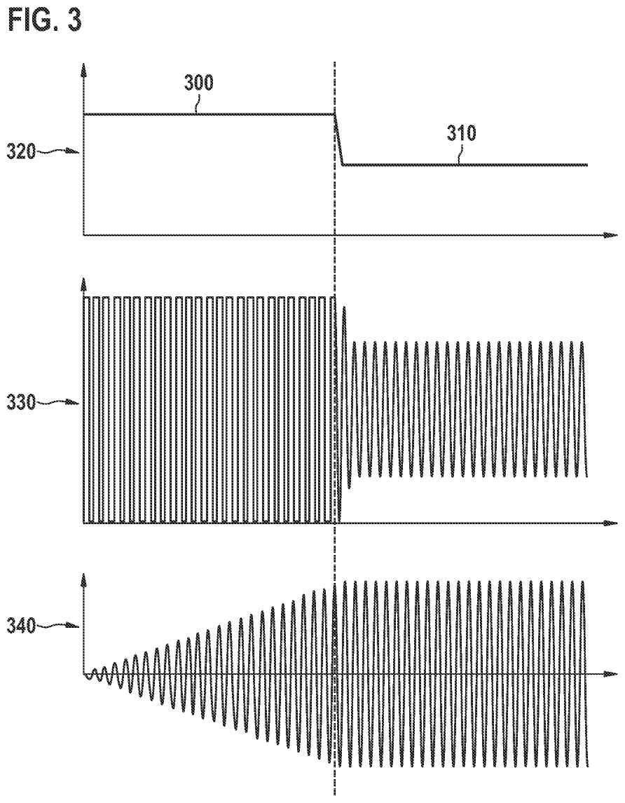

FIG. 3 shows several graphs which schematically illustrate the functioning of the micromechanical sensor system 100 according to the present invention or the rotation rate sensor according to a first embodiment of the present invention. All of the graphs show the temporal progression (abscissa) of the respective measured variable (ordinate). The graphs also all show a start-up mode 300 and an operating mode 310. A sleep mode of the rotation rate sensor or the seismic mass 110 (chronologically before the start-up or the start of the drive or the drive oscillation of the seismic mass 110) is not shown but can be imagined. The illustration in FIG. 3 shows the change from the start-up mode 300 to the operating mode 310 to be comparatively abrupt. In a further embodiment of the present invention, not shown here, the transition from the start-up mode 300 to the operating mode 310 takes place (comparatively) successively or incrementally, or during a (in comparison to the illustration in FIG. 3) longer time interval. A graph 320 presented in the upper part of FIG. 3 shows the offset voltage 150 (or different values of the offset voltage 150) in the different working modes of the rotation rate sensor (start-up mode 300 or operating mode 310). With the (comparatively abrupt) change from the start-up mode 300 to the operating mode 310, according to the first embodiment of the present invention, the offset voltage is changed from a (comparatively) high value, e.g. 20-30V, to a (comparatively) low value, e.g. 10-20V. In the middle part of FIG. 3, the graph 330 shows the drive voltage applied to the electrode 130 or 130′, respectively. With the change from the start-up mode 300 to the operating mode 310, the applied drive voltage is switched from the control with the maximum voltage available from the driver of the drive voltage to excitation via a control and then remains at a lower level in the operating mode 310. In this case, the maximum voltage available from the driver of the drive voltage that can be used in the start-up mode and in the operating mode is constant. In the lower part of FIG. 3, a graph 340 is plotted, which shows the output parameter or the output signal 170 of the drive of the seismic mass 110 of the micromechanical sensor system 100 according to the present invention. It can be seen that the oscillation amplitude of the seismic mass 110 increases steadily from a resting state (chronologically before the start-up mode 300) during the start-up mode 300 and remains largely constant during the operating mode 310. In the start-up mode 300, the amplitude of the oscillation increases, shown here schematically as linear, while the frequency remains the same. With the change to the operating mode 310, the amplitude of the oscillation of the seismic mass 110 remains the same as well; during the operating mode 310, the sensor system is ready.

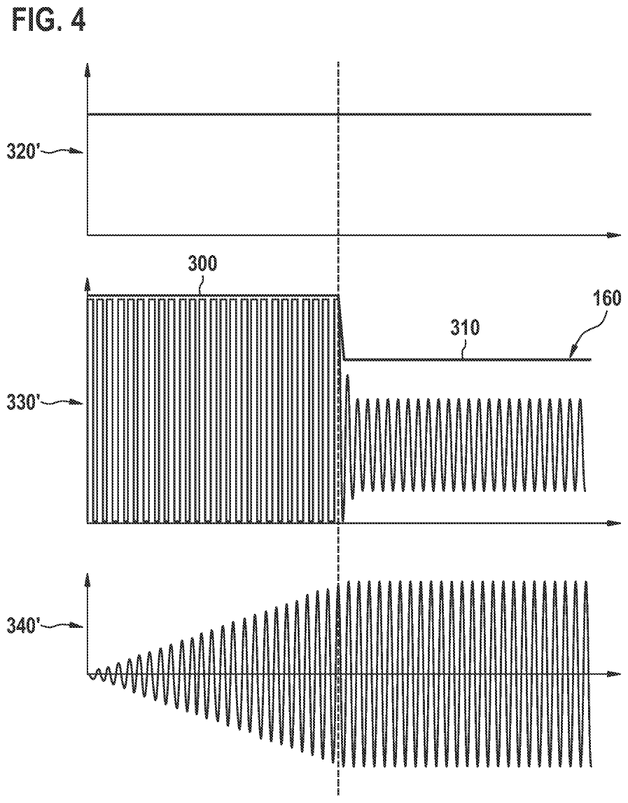

FIG. 4 shows several graphs which schematically illustrate the functioning of the micromechanical sensor system 100 according to the present invention or the rotation rate sensor according to a second embodiment of the present invention. The illustration according to FIG. 4 is analogous to the illustration in FIG. 3: a graph 320′ of the offset voltage, a graph 330′ of the forces acting when driving the seismic mass 110 or the force signal of the drive, and a graph 340′ of the output parameter or the output signal 170 of the drive of the seismic mass 110, in each case as a function of time. As can be seen from the illustration in 320′, the offset voltage 150 according to the second embodiment of the present invention remains at the same level or value in both the start-up mode 300 and the operating mode 310. According to the second embodiment, however, the maximum voltage 160 available from the driver of the drive voltage has an amplitude that is higher in magnitude in the start-up mode 300 than in the operating mode 310. This use of different amplitudes of the maximum voltage 160 available from the driver of the drive voltage in the different working modes 300, 310 leads to an increased maximum action of force when driving the seismic mass 110 or a force signal of the drive between the electrodes 120, 130 or 130 during the start-up mode 300 relative to the operating mode 310 in the second embodiment as well. In the transition from the start-up mode 300 to the operating mode 310, the maximum voltage 160 available from the driver of the drive voltage is again regulated down comparatively abruptly from a (comparatively) high value to a (comparatively) low value, because a lower regulated drive voltage is sufficient in the operating mode.

According to the present invention, it is thus provided according to the first embodiment that the offset voltage 150 (or its magnitude) is reduced during the transition from the start-up mode 300 to the operating mode 310 and the maximum voltage 160 available from the driver of the drive voltage is kept constant, while, according to the second embodiment, it is provided that the maximum voltage 160 available from the driver of the drive voltage (or its value) is reduced and the offset voltage 150 (or its magnitude) is maintained during the transition from the start-up mode 300 to the operating mode 310. According to further (not shown) embodiments according to the present invention, however, it is also provided that the two measures are combined. According to the present invention, it is also possible to make the transition between the start-up mode 300 and the operating mode 310 less abrupt, for example extend the discussed change of the values of the offset voltage 150 and/or the maximum voltage 160 available from the driver of the drive voltage over a longer time interval. According to the present invention, a slow start-up time (or a longer time interval of the start-up mode 300) when using a low offset voltage in the steady state (i.e. in the operating mode 310) is overcome; i.e. freely selecting the offset voltage 150 and/or the maximum voltage 160 available from the driver of the drive voltage during the start-up mode 300 or the operating mode 310 (or the dynamic change thereof) makes it possible to achieve the best performance of the rotation rate sensor (during the operating mode 310) and at the same also achieve a comparatively short start-up time (start-up mode 300).

According to the first embodiment, the CM (common-mode) voltage, i.e. the offset voltage 150, is dynamically changed during the transition between the start-up mode 300 and the operating mode 310, in particular kept high during the start-up of the sensor and/or the drive of the seismic mass 110 (start-up mode 300), in order to minimize the time required to achieve the correct oscillation amplitude (in the operating mode 310). After that (during the transition to the operating mode 310), the CM voltage is reduced to a value that optimizes the overall performance of the rotation rate sensor in the steady state. In this last state, which corresponds to the normal operation of the device when it is switched on (operating mode 310), the lower force caused by a lower CM voltage can easily be compensated by increasing the Q-factor of the mechanical structure. When powering up, on the other hand, increasing the Q-factor does not contribute significantly to reducing the power-up time (or the start-up mode 300), whereas a higher CM voltage does. Therefore, according to the present invention, (according to the first embodiment), the block that generates the CM voltage, typically the charge pump/CM driver 150, can be configured such that at least two operating voltages are possible. During the start-up phase, the block is configured such that it generates a higher voltage, which makes it possible to increase the driving force and thus allow the oscillation amplitude to increase more quickly. When the amplitude reaches the target value or slightly earlier, the CM voltage is reduced until the steady state is achieved. This reduction can be incremental or in the form of a ramp, depending on the circuit being implemented and the device's response to such a voltage change.

The gain of the signal path that reads the amplitude (i.e. the output parameter or the output signal 170 of the drive of the seismic mass 110) has to be adjusted accordingly or can be kept constant and only the target value adjusted to compensate the different sensitivity due to the different CM voltage.

According to the second embodiment, it is possible according to the present invention to achieve a similar result by keeping the CM voltage constant (both during the start-up mode 300 and the operating mode 310) and reducing the maximum amplitude of the drive voltage applied to the drive electrodes 120, 130, 130′.

According to the present invention, it is further provided that a square wave voltage is used as the drive voltage during the start-up mode and to then switch to a sine wave voltage as the drive voltage in the operating mode (the switching steps for changing the work mode). Excitation with a sine wave voltage avoids the occurrence of undesirable, high-frequency spectral components of the stimulating driving forces (that occur with square-wave excitation) in the operating mode.

What is claimed is:

1. A micromechanical sensor system, comprising:
a rotation rate sensor which includes a seismic mass that can be excited to oscillate, and a driver for the seismic mass;
wherein, for driving the seismic mass, the seismic mass is subjected to an offset voltage and a drive voltage which is generated or made available by the driver, wherein the seismic mass is excited to oscillate using the drive voltage in the form of an AC voltage;
wherein the rotation rate sensor is selectively operable in a start-up mode and in an operating mode, wherein:
the offset voltage during operation of the rotation rate sensor in the start-up mode is different from the offset voltage during operation of the rotation rate sensor in the operating mode, and/or
a maximum voltage available from the driver of the drive voltage during operation of the rotation rate sensor in the start-up mode is different from the maximum voltage available from the driver of the drive voltage during operation of the rotation rate sensor in the operating mode.

2. The micromechanical sensor system according to claim 1, wherein the offset voltage is 20 to 30V in the start-up mode and 10 to 20V in the operating mode and/or the maximum voltage available from the driver of the drive voltage is 3 to 5V in the start-up mode and 1.5 to 3V in the operating mode.

3. The micromechanical sensor system according to claim 1, wherein the offset voltage is generated or is applied using a charge pump.

4. The micromechanical sensor system according to claim 1, wherein the drive voltage for the seismic mass in the operating mode is maintained by adjusting the quality factor of the mechanical structure.

5. The micromechanical sensor system according to claim 1, wherein the maximum voltage available from the driver of the drive voltage and/or the offset voltage is changed incrementally or abruptly from the start-up mode to the operating mode, wherein the drive voltage in the form of an AC voltage corresponds to a square wave voltage during operation of the rotation rate sensor in the start-up mode and corresponds to a sine wave voltage during operation of the rotation rate sensor in the operating mode.

6. The micromechanical sensor system according to claim 1, wherein the rotation rate sensor is operable in a sleep mode and the sleep mode is carried out chronologically before the start-up mode and the operating mode, wherein a period of time between the sleep mode and the operating mode corresponds to a time interval of the start-up mode and wherein the time interval includes a period of time of less than 100 milliseconds.

7. A method for operating a micromechanical sensor system with a rotation rate sensor, which includes a seismic mass that can be excited to oscillate and a drive device for the seismic mass, wherein the drive device is configured such that, for driving, the seismic mass is subjected to an offset voltage and a drive voltage, wherein the seismic mass is excited to oscillate using the drive voltage in the form of an AC voltage, the method comprising:
selectively operating the rotation rate sensor in a start-up mode and in an operating mode, wherein:
the offset voltage during operation of the rotation rate sensor in the start-up mode is different from the offset voltage during operation of the rotation rate sensor in the operating mode, and/or
a maximum voltage available from a driver of the drive voltage during operation of the rotation rate sensor in the start-up mode is different from the maximum voltage available from the driver of the drive voltage during operation of the rotation rate sensor in the operating mode.
